(19) United States
(12) Patent Application Publication
(10) Pub. No.: US 2008/0192928 A1
(43) Pub. Date: Aug. 14, 2008

(54) Portable Electronic Storage Devices with Hardware Security Based on Advanced Encryption Standard

(75) Inventors: I-Kang Yu, Palo Alto, CA (US); David Q. Chow, San Jose, CA (US); Charles C. Lee, Cupertino, CA (US); Abraham Chih-Kang Ma, Fremont, CA (US); Ming-Shiang Shen, Hsin Chuang (TW)

Correspondence Address: ROGER H. CHU, 19499 ERIC DRIVE, SARATOGA, CA, 95070, US

(73) Assignee: SUPER TALENT ELECTRONICS, INC., San Jose, CA (US)

(21) Appl. No.: 11/924,448

(22) Filed: Oct. 25, 2007

Related U.S. Application Data
(63) Continuation-in-part of application No. 11/624,667, filed on Jan. 18, 2007.
Application No. 11/624,667 is a division of application No. 09/478,720, filed on Jan. 6, 2000, now Pat. No. 7,257,714.
Application No. 09/478,720 is a continuation-in-part of application No. 11/674,645, filed on Feb. 13, 2007.
Application No. 11/674,645 is a continuation-in-part of application No. 11/466,759, filed on Aug. 23, 2006.
Application No. 11/466,759 is a continuation-in-part of application No. 10/789,333, filed on Feb. 26, 2004, now Pat. No. 7,318,117.
Application No. 10/789,333 is a continuation-in-part of application No. 11/742,270, filed on Apr. 30, 2007.
Application No. 11/742,270 is a continuation-in-part of application No. 10/957,089, filed on Oct. 1, 2004.
Application No. 10/957,089 is a continuation-in-part of application No. 11/864,696, filed on Sep. 28, 2007.
Application No. 11/864,696 is a continuation-in-part of application No. 10/854,004, filed on May 25, 2004.
Application No. 10/854,004 is a continuation-in-part of application No. 10/708,172, filed on Feb. 12, 2004, now Pat. No. 7,021,971.
Application No. 10/708,172 is a continuation-in-part of application No. 11/685,143, filed on Mar. 12, 2007.
Application No. 11/685,143 is a continuation-in-part of application No. 11/770,642, filed on Jun. 28, 2007.
Application No. 11/770,642 is a continuation-in-part of application No. 10/818,653, filed on Apr. 5, 2004, now Pat. No. 7,243,185.

(51) Int. Cl. H04L 9/28; H04L 9/00; G06F 12/14

(52) U.S. Cl. 380/44; 380/28; 713/165

(57) ABSTRACT

Portable electronic storage devices with hardware based security are described. According to one exemplary embodiment of the present invention, a portable electronic storage device (PESD) comprises a security engine integrated thereon. The security engine is configured to provide data encryption, data decryption, and encryption/decryption key (referred to as a key) generation according to a security standard (e.g., Advance Encryption Standard (AES)). AES is a symmetric encryption algorithm processing data in block of 128 bits. Under the influence of a key, a 128-bit data block is encrypted by transforming the data block in a unique way into a new data block of the same size. AES is symmetric sine the same key is used for encryption and the reverse transformation (i.e., decryption). The only secret necessary to keep for security is the key. AES may use different key-lengths (i.e., 128-bit, 192-bits and 256-bits).

### CROSS-REFERENCE TO RELATED APPLICATIONS

This application is a continuation-in-part (CIP) of co-pending U.S. patent application Ser. No. 11/624,667 filed on Jan. 18, 2007, entitled “Electronic data Storage Medium with Fingerprint Verification Capability”, which is a divisional patent application of U.S. patent application Ser. No. 09/478,720 filed on Jan. 6, 2000, now U.S. Pat. No. 7,257,714.

This application is also a CIP of co-pending U.S. patent application Ser. No. 11/674,645 filed on Feb. 13, 2007, entitled “Recycling Partially-Stale Flash Blocks Using a sliding Window for Multi-Level-Cell (MLC) Flash Memory”, which is a CIP of co-pending U.S. patent application Ser. No. 11/466,759 filed on Aug. 23, 2006, entitled “Flash Memory Controller for Electronic Data Flash Card”, which is a CIP of U.S. patent application Ser. No. 10/789,333 filed on Feb. 26, 2004 entitled “System and Method for Controlling Flash Memory”.

This application is also a CIP of co-pending U.S. patent application Ser. No. 11/742,270 filed on Apr. 30, 2007, entitled “Two-Level RAM Lookup Table for Block and Page Allocation and Wear-Leveling in Limited Write Flash-Memories”, which is a CIP of U.S. patent application Ser. No. 10/957,089 filed on Oct. 1, 2004, entitled “Flash Card Systems”.

This application is also a CIP of co-pending U.S. patent application Ser. No. 11/864,696 filed on Sep. 28, 2007, entitled “Backward Compatible Extended USB Plug and Receptacle with Dual Personality”, which is a CIP of U.S. patent application Ser. No. 10/854,004 filed on May 25, 2004, entitled “Extended Secure-Digital Card Devices and Hosts”, which is a CIP of U.S. patent application Ser. No. 10/708,712 filed on Feb. 12, 2004 entitled “Dual-personality Extended-USB Plug and Receptacle with PCI-Express or Serial-AT-Attachment Extensions”, now U.S. Pat. No. 7,021,971.

This application is also a CIP of co-pending U.S. patent application Ser. No. 11/685,143 filed on Mar. 12, 2007, entitled “Data Security for Electronic Data Flash Card”.

This application is also a CIP of co-pending U.S. patent application Ser. No. 11/770,642 filed on Jun. 28, 2007, entitled “High-Speed Controller for Phase-Change Memory Peripheral Device”, which is a CIP of U.S. patent application Ser. No. 10/818,653, filed on Apr. 5, 2004, now U.S. Pat. No. 7,243,185.

### FIELD OF THE INVENTION

The present invention relates to portable electronic storage devices (PESD), and more particularly to portable electronic storage devices with data security feature included therein.

### BACKGROUND OF THE INVENTION

Portable electronic storage devices have become widely accepted and used by consumers. A portable electronic storage device (PESD) uses flash memory as non-volatile storage. There are many types of PESD including, Multi-Media Card (MMC), Secure Digital (SD), micro Secure Digital (micro-SD), Compact Flash (CF), Memory Stick (MS) or Memory Stick-Pro (MS-Pro), Solid State Drive or Disk (SSD), Universal Serial Bus (USB) based flash memory device, etc.

Due to similarities between the MMC and SD standards (e.g., form factors and construction, locations of connectors, contact pads, etc.), MMC and SD cards are collectively referred to herein as “MMC/SD” cards unless separately specified.

Many of the PESD do not include any security measures. The data stored on the PESD can be accessed and read by any person who gets hold on the PESD. Worse, the data may be compromised even if the owner of the PESD simply misplaces the PESD. One such prior art PESD is shown in FIG. 1A. The PESD.100 comprises a flash memory 102, a controller 104(e.g., flash memory controller), and an input/output (I/O) interface 106. The controller 104 is configured to control read and/or write operations to the flash memory 102. The I/O interface 106 coupled to the flash memory controller 104 is adapted to provide data input and output of the PESD 100. The PESD 100 provides a data storage to a host 120 (e.g., a computing device, a consumer electronic device, etc.) via an interface bus 110 (e.g., USB, Serial Advanced Technology Attachment (SATA)). The interface bus 110 transmits the data, signals and power between the host 120 and the PESD 100.

Since there is no security measures included in the PESD 100, the data stored in the flash memory 102 may be accessed by any host device 120 that is capable of accessing data from the PESD. Lack of security on this type of PESD creates a huge security risk for sensitive data (e.g., financial records, personal information, secret data, etc.).

One of the solutions to the security problem is to include a means to identify the owner of a PESD. FIG. 1B shows a prior art PESD that include a finger print sensor for owner identification. The finger print sensor PESD 140 comprises a flash memory 142, a processing unit 144, an I/O interface 146, a power source 150, a display 152, at least one functional key 154 and a finger print sensor 158. The processing unit 144 is a core of the PESD 140 as all other components are coupled thereto. Read and write operations to the flash memory 142 are controlled by a controller (not shown) coupling to the processing unit 144. The I/O interface 146 is configured to provide data input and output of the PESD 140. The power source 150 provides the power to the processing unit 144 as requirements for power is much more significant due to processing of finger print. The display 152 is configured to provide output from the processing unit 144, while the functional key set 154 is configured to provide input. The finger print sensor 158 is configured to scan the finger print of the owner of the PESD 140. The PESD 140 is configured to provide data storage to a host 170. Signals, data (in form of data packets) and power are transmitted via the interface bus 160 such as USB, SATA, etc.

Although the finger print sensor PESD 140 can provide certain level of security to the data stored on the PESD 140, there are problems with this approach. The drawbacks are as follows: 1) costs associated with manufacturing PESD with finger print sensor are high; 2) complexity related to data sharing when a group of users; 3) finger print sensor may not be reliable as finger print may be altered; and 4) comparison of scan finger print with a reference print may not always be reliable.

Therefore it would be desirable to provide a PESD with high level of security measures built-in for data stored therein without cost ineffective or not always reliable solutions.

### BRIEF SUMMARY OF THE INVENTION

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Portable electronic storage devices with hardware based security are disclosed. According to one aspect of the present invention, a portable electronic storage device (PESD) comprises a security engine integrated thereon. The security engine is configured to provide data encryption, data decryption, and encryption/decryption key (referred to as a key) generation according to a security standard (e.g., Advance Encryption Standard (AES)). AES is a symmetric encryption algorithm processing data in block of 128 bits. Under the influence of a key, a 128-bit data block is encrypted by transforming the data block in a unique way into a new data block of the same size. AES is symmetric since the same key is used for encryption and the reverse transformation (i.e., decryption). The only secret necessary to keep for security is the key. AES may use different key-lengths (i.e., 128-bit, 192-bits and 256-bits).

In another aspect, a security engine is configured to be located on a host that is capable of performing data transactions (i.e., read/write operation) with a PESD. Unencrypted data is encrypted on the host before transmitting to the PESD. Encrypted data stored on the PESD is transmitted to the host before being decrypted. The security engine may be implemented in hardware, software or combination of both. The PESD operates the same way as the PESD without any security measures; however, data stored on the PESD are encrypted hence secured.

In yet another aspect, the present invention requires a data encryption/decryption security password to turn on data encryption/decryption. In other words, the security engine may only be activated when a correct encryption/decryption security password has been entered. As a result, a mixed mode of data operation may be implemented. In other words, data stored on a PESD may be encrypted and unencrypted depending upon which mode (encryption/decryption ON or OFF). Because data operations either read or write are in a data file basis, a data file password would provide additional security to those data files have a data file password.

In still another aspect, the encryption key may be created by a manufacturer of a PESD and stored in a system area of the flash memory. The same key may be used for encryption for all data stored on the PESD. Alternatively, the key may be generated for each data file using the data file password.

According to one exemplary embodiment of the present invention, a portable electronic storage device (PESD) includes at least a security engine configured to provide data encryption and data decryption when required, the security engine includes a key generator for generating and/or holding a key used for the data encryption and the data decryption; a flash memory configured to provide data storage; a controller or microcontroller configured to control the flash memory and the security engine; and an internal data bus configured to provide data and control signal transmission among the controller, the security engine and the flash memory within the PESD.

The PESD further includes a data error corrector configured to provide data reliability using an error-correcting code (ECC) scheme; a page register configured to hold data in a static random access memory for fast direct memory access; and an input/output (I/O) interface configured to provide data transfer between a host and the PESD.

One of the objects, features, and advantages of the present invention is to provide a built-in data security for portable electronic storage devices. Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1A is a block diagram showing a prior art flash memory device;

FIG. 1B is a block diagram showing another prior art flash memory device with finger print verification capability;

FIG. 2 is a block diagram showing salient components of an exemplary portable electronic storage device (PESD) with an Advanced Encryption Standard (AES) based hardware security engine integrated therein, according to an embodiment of the present invention;

FIG. 3A is a diagram depicting a first exemplary environment in which one embodiment of the present invention is implemented;

FIG. 3B is a diagram depicting a second exemplary environment in which another embodiment of the present invention is implemented;

FIG. 3C is a diagram depicting a third exemplary environment in which yet another embodiment of the present invention is implemented;

FIG. 4A is a block diagram illustrating data and control signal paths of a PESD with an AES security engine integrated therein, according to an embodiment of the present invention;

FIG. 4B is a block diagram showing salient components of the AES engine of FIG. 4A;

FIG. 5A is a flow chart showing an exemplary process of secured data input and/or output to and from a PESD in the first exemplary environment of FIG. 3A in accordance with one embodiment of the present invention;

FIG. 5B is a flow chart showing an exemplary process of secured data input and/or output to and from a PESD in either the second or the third exemplary environment of FIG. 3B or FIG. 3C, respectively, in accordance with one embodiment of the present invention;

FIG. 6 is a flow chart showing an exemplary process of creating a password to enable secured data input and/or output to and from a PESD in accordance with one embodiment of the present invention;

FIGS. 7A-D are flow charts showing various options of performing secured data input and output in the AES security engine of FIG. 4B, according to one embodiment of the present invention;

FIGS. 8A-8C are a series of tables showing an exemplary solution for multi-time programming problem encountered in Multi-Level-Cell flash memory based PESD; and

FIGS. 9A-9G are block diagrams illustrating various data access schemes between a flash memory controller and flash memory including Single-Level-Cell and Multi-Level-Cell used in PESD.

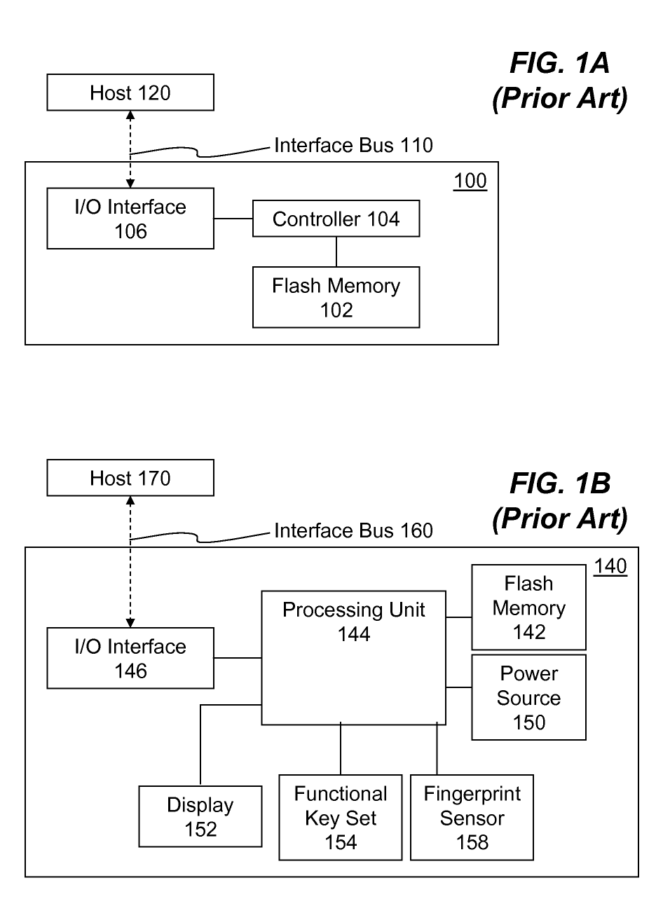

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Used herein, the terms “upper”, “lower”, “top”, “bottom”, “middle”, “upwards”, and “downwards” are intended to provide relative positions for the purposes of description, and are not intended to designate an absolute frame of reference. Further, the order of blocks in process flowcharts or diagrams representing one or more embodiments of the invention do not inherently indicate any particular order nor imply any limitations in the invention.

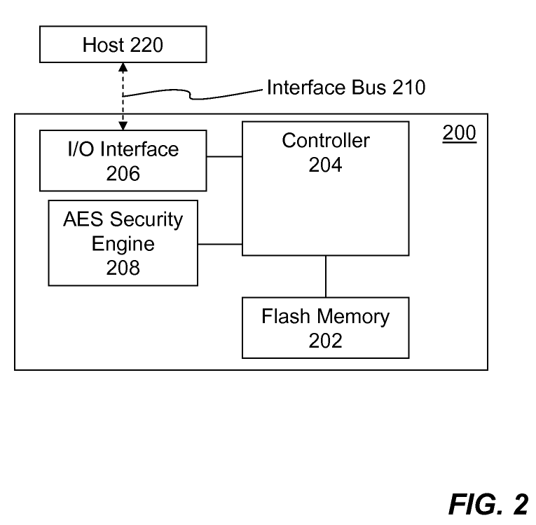

Embodiments of the present invention are discussed herein with reference to FIGS. 2-9G. However, those skilled in the art will readily appreciate that the detailed description given herein with respect to these figures is for explanatory purposes as the invention extends beyond these limited embodiments.

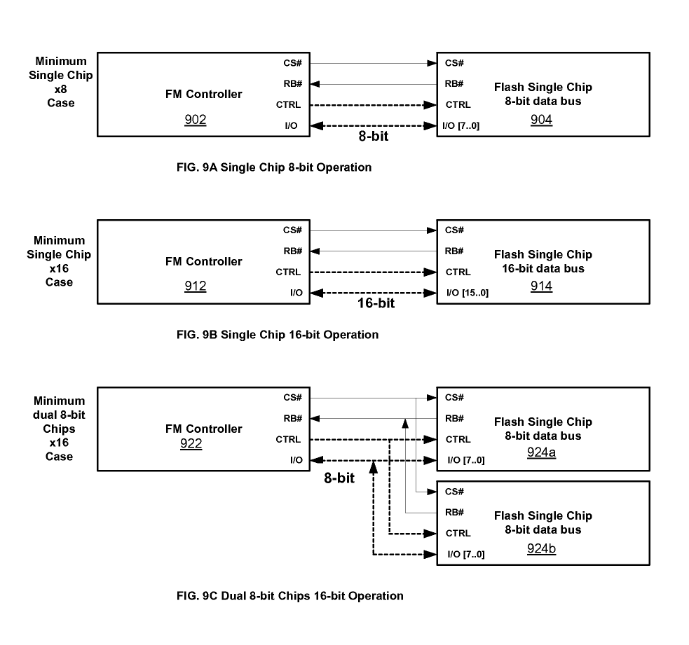

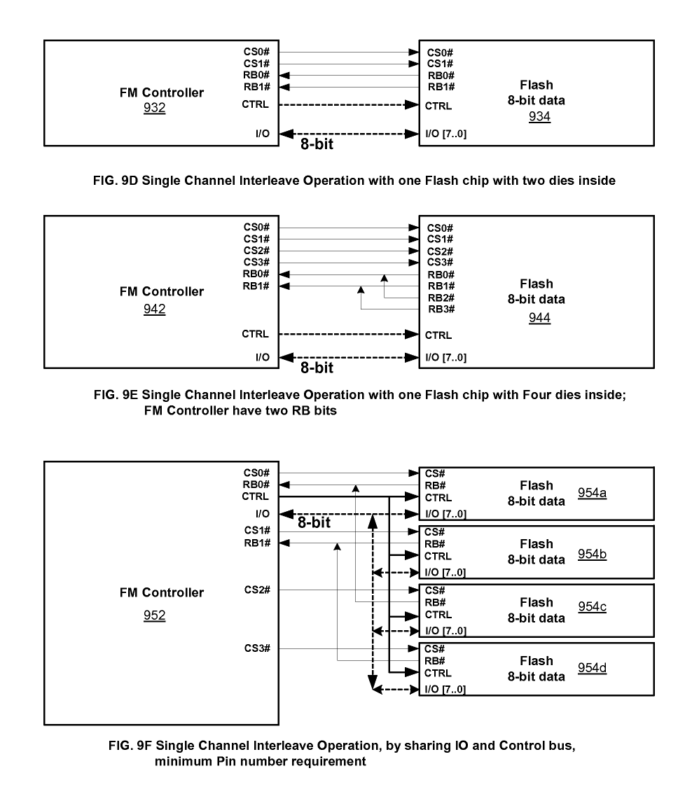

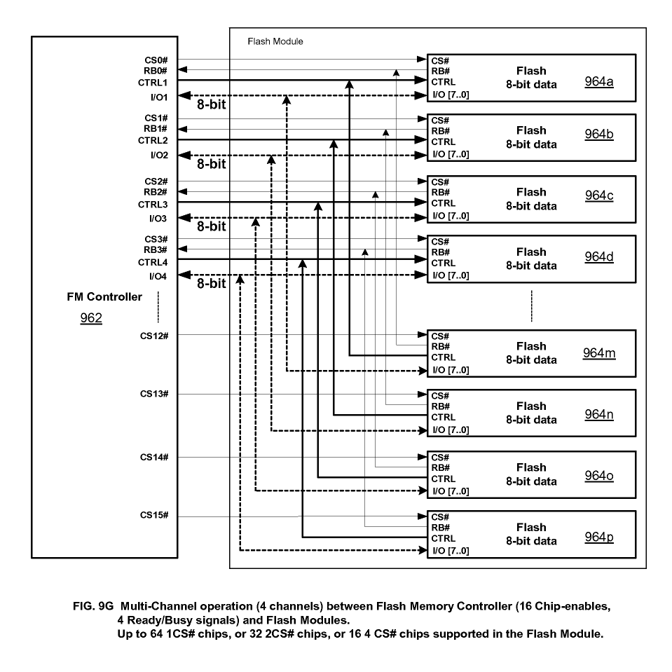

Referring now to the drawings, in which like numerals refer to like parts throughout several views. FIG. 2 shows a block diagram of an exemplary portable electronic storage device (PESD) 200 with an Advanced Encryption Standard (AES) based hardware security engine 208 integrated therein, according to an embodiment of the present invention. The PESD 200 (e.g., a flash memory storage card) comprises one or more flash memory devices 202, a controller or micro-controller 204, an input/output (I/O) interface 206 (e.g., a USB interface), and an AES security engine 208. The controller 204 is configured to control the one or more flash memory devices 202 and the AES engine 208. The one or more flash memory devices 202 comprise either single-level-cell (SLC) or multi-level-cell (MLC) flash memory. Detailed descriptions of various configurations of flash memory device are shown in FIGS. 9A-9G below. The AES engine 208 is configured to perform data encryption and data decryption. The controller 204 is configured to transmit data, signals and power via the I/O interface 206 to a host 220. The I/O interface 206 is configured to adapt data, signals and power in accordance with a standard, for example, USB, SATA, SSD, MMC/SD, micro-SD, MS, CF, etc. The host 220 comprises a computing device (e.g., a personal computer, a consumer electronic device, etc.) capable of transmitting data, signals and power to and from the PESD 200 via an interface bus 210 (e.g., USB, SATA, etc.).

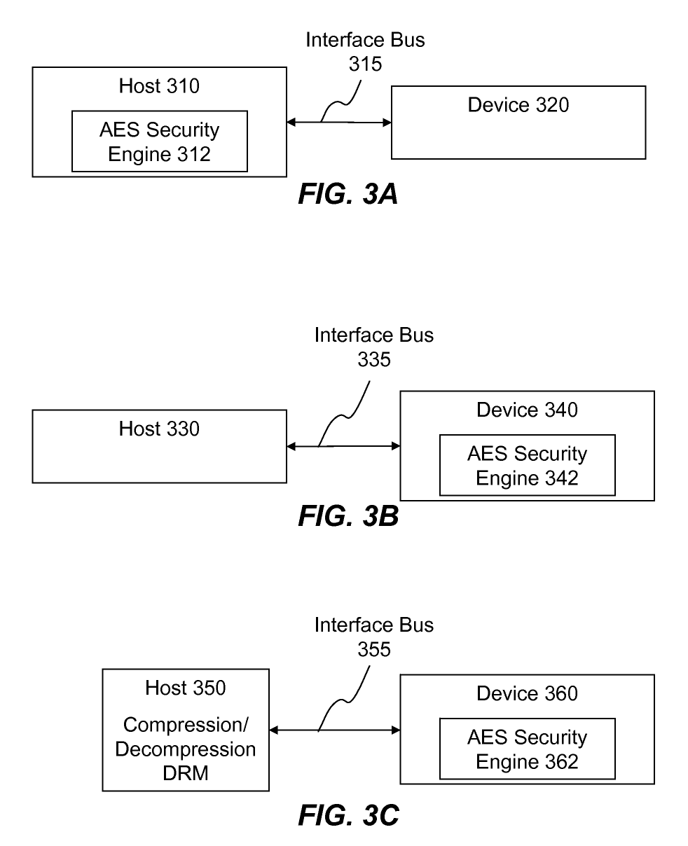

FIGS. 3A, 3B and 3C show three exemplary environments, an embodiment of the present invention may be implemented in each of which. A first exemplary environment, shown in FIG. 3A, includes a device 320 coupling to a host 310 via an interface bus 315. The device 320 comprises a PESD without any security measure. An AES security engine 312 is adapted to the host 310 as software, hardware or a combination of both. In the first environment, the security of the data stored on the device 320 is protected using AES data encryption performed on the AES security engine 312 installed or integrated on the host 310 (e.g., a computing device). In other words, the data stored on the device 320 are encrypted with a key, which can only be accessed by an owner of the device 312, because the key is protected by a security password only known to the owner. Thus, the data would render useless when compromised, for example, even data is illegitimately accessed, but the encrypted data are not readable without the key. In general, encrypted data stored on the device 320 can only be accessed by the host 310, because the AES security engine 312 can decrypt the encrypted data using a same algorithm and key. However, in certain situations, other hosts may be able to access the encrypted data. For example, the secret algorithm and key are given and installed on other hosts.

A second environment shown in FIG. 3B comprises a device 340 coupling to a host 330 via an interface bus 335. In contrast to the first environment, an AES based hardware security engine 342 is adapted or installed to the device 340 instead of the host 330. Data security is achieved by data encryption performed by the AES security engine 342. The AES based hardware security engine 342 may be implemented using integrated circuits (e.g., Application Specific Integrated Circuit (ASIC), Field Programmable Gate Array (FPGA), etc.). Similar to the first environment, data stored on the device 340 are encrypted with a key only known to the owner of the device 312. The device 340 may be accessed by other hosts equipped with the same interface bus 335.

FIG. 3C shows a third environment, which is a variation of the second environment. The third environment comprises an AES based hardware security engine 362 adapted to a device 360, and a host 350 coupling to the device 360 via an interface bus 355. The difference between the third and the second environment is that the host 350 is configured to perform data compression and decompression in accordance with certain access control standards (e.g., digital rights management or digital restrictions management (DRM)). The compressed data is then encrypted and stored on the device 360. The encryption and decryption of the compressed data are performed by the AES based hardware security engine 362 with a key known to the owner of the device 360.

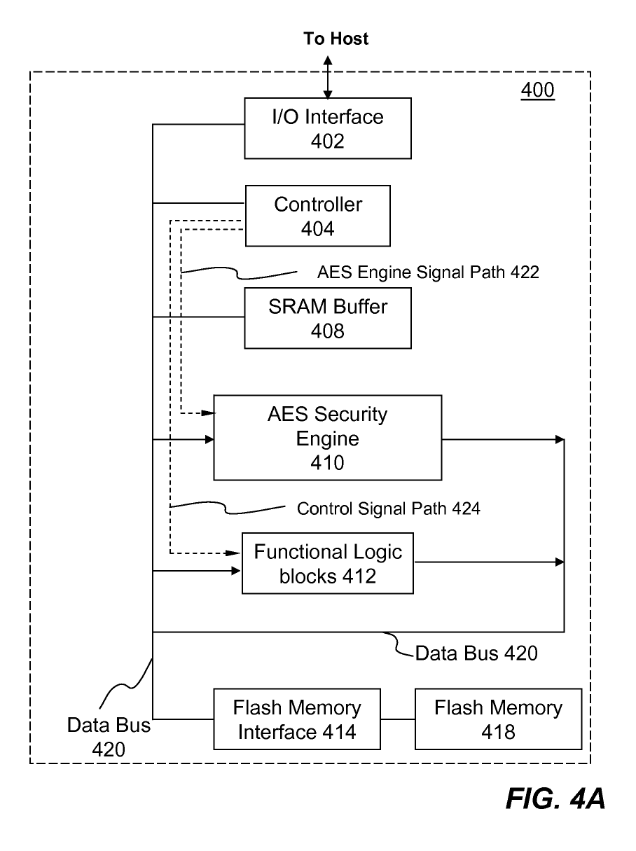

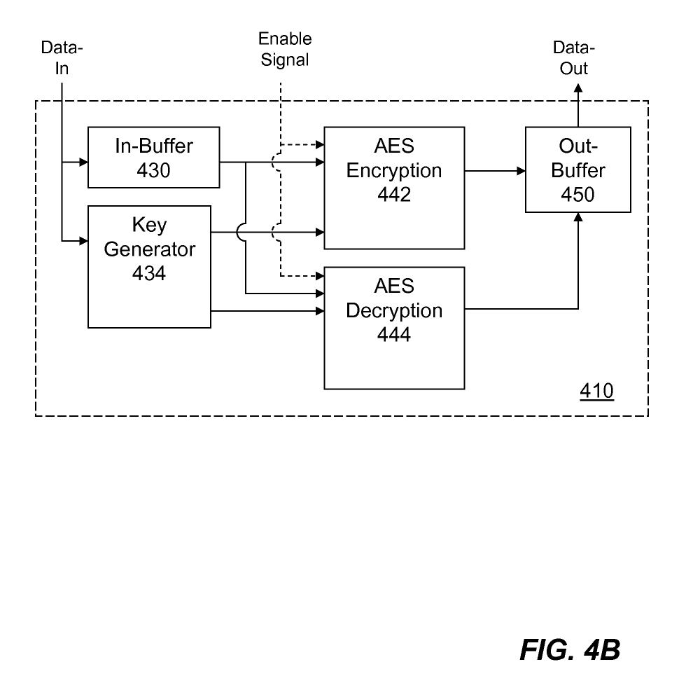

FIG. 4A is a block diagram showing data flow and control signal path of a device 400 with an AES security engine 410 (e.g., AES security engine 342 of FIG. 3B or AES security engine 362 FIG. 3C), according to an embodiment of the present invention. The device 400 comprises an I/O interface 402, a controller or micro-controller 404, a static random access memory (SRAM) buffer or page register 408, an AES security engine 410, other functional logic blocks 412 (e.g., a data error corrector using Error Correction Code (ECC) technique), a flash memory interface 414 and at least one flash memory device 418. An internal data bus 420 is configured to provide data transmission within the device 400. The internal data bus 420 is depicted as solid lines with arrow, which indicate direction of data flows. For example, data are directed to the AES security engine 410 and other functional logic blocks 412 for processing, then the processed data are sent out. Unencrypted data are sent to the AES security engine 410 for encryption, while encrypted data are for decryption. The control signal path (e.g., AES security engine control signal path 422 and control signal path 424) are indicated as dotted lines.

The I/O interface 402 is configured to provide data, signals and power transmission to and from the host (not shown) in accordance with one of the standards (e.g., USB, SATA, etc.). The controller 404 is configured to provide controls to retrieve and store data to the at least flash memory device 418 via the flash memory interface 414. The controller 404 is further configured to provide controls to the AES security engine 410 such that data are encrypted and decrypted accordingly. Controls to other functional logic blocks 412 (e.g., data error corrector) are also provided by the controller 404. The SRAM buffer 408 is configured to provide directed memory access (DMA) so that the AES security engine 410 can perform data encryption/decryption without delay due to slower flash memory access. The data error corrector may be configured to create ECC parity or other overhead information to ensure data can be stored and retrieved with high reliability, for example, a 4-bit ECC represents an ECC code may correct up to four (4) individual error bits. In one embodiment, Reed-Solomon technique is used in the ECC data error corrector so that data error within the threshold of the Reed-Solomon technique can be recovered. In another embodiment, a BCH (Bose, Ray-Chaudhuri, Hocquenghem) code is used for data error correction.

FIG. 4B is a block diagram illustrating further details of the AES security engine 410 of FIG. 4A. The AES engine 410 comprises an in-buffer 430, an out-buffer 450, an AES data encryption logic block 442, an AES data decryption logic block 444 and a key generator 434. Data flow paths are shown using solid lines with arrow. Control signal paths (e.g., enable signal for data encryption and/or decryption) are shown with dotted lines. The in-buffer 430 is configured to receive data as indicated by data-in. The key generator 434 is configured to generate and/or hold a key used in data encryption and data decryption. The AES encryption logic block 442 is configured to encrypt the received data from the in-buffer 430 using the key from the key generator 434. The AES decryption logic block 444 is configured to decrypt the received data from the in-buffer 430 using the key from the key generator 434. In one embodiment, the encryption key and decryption key are the same as symmetry keys. The out-buffer 450 is configured to hold processed data from either the AES encryption logic block 442 or the AES decryption logic block 444.

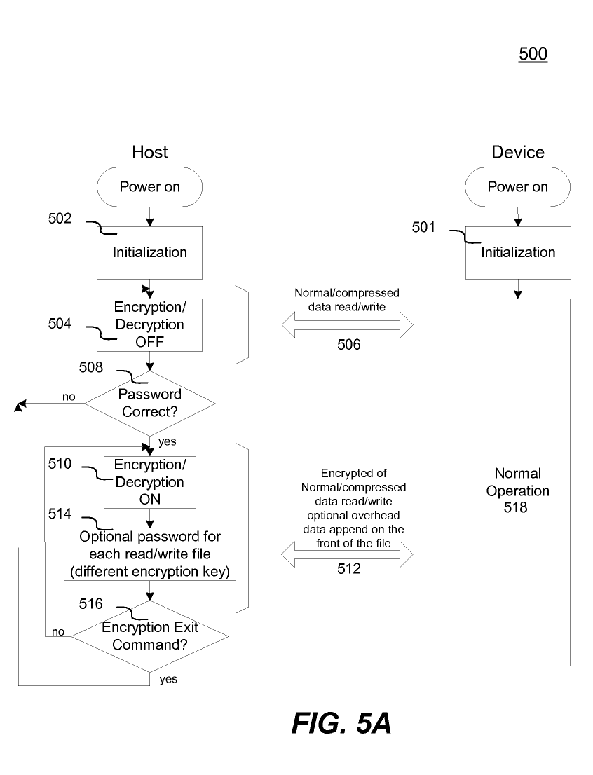

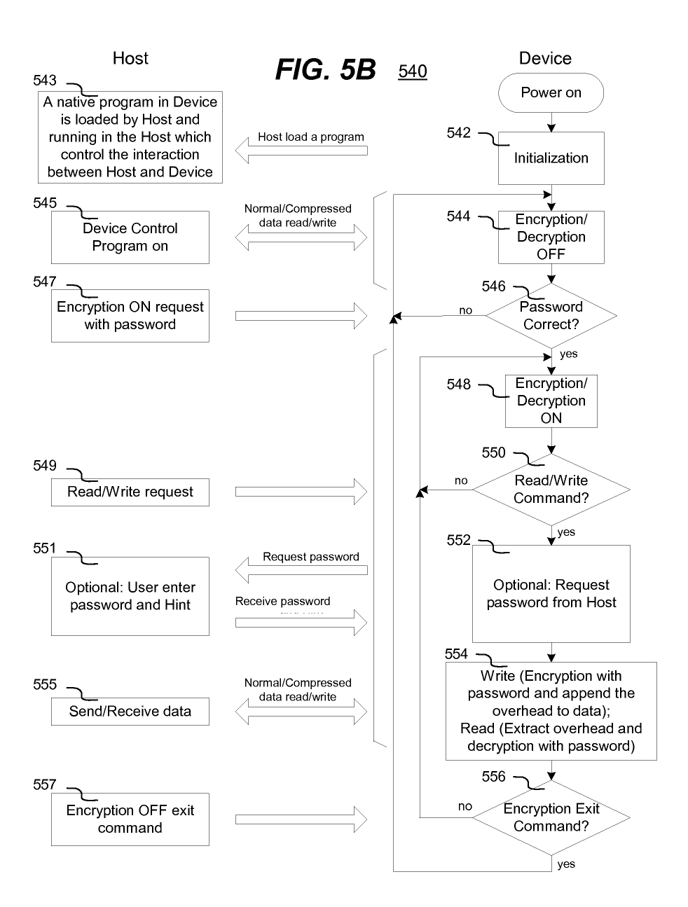

FIG. 5A is a flow chart illustrating an exemplary process 500 of providing data security for the device 320 (e.g., PESD) with the AES security engine 312 on the host 310 in the first exemplary environment (FIG. 3A). The process 500 starts with the device 320 electrically connected to the host 310, for example, a PESD plugged into a computing device. At this point, the device 320 receives power from the host 310. The device 320 is then initialized at 501. The host 320 initializes with a control program in the AES security engine 312 at 502. In one embodiment, the initial operation mode is set to an “AES security OFF” or “encryption/decryption OFF” state at 504. Data transmission between the host 310 and the device 320 is conducted without any AES security in the “encryption/decryption OFF” state at 506. Next, when AES security is desired, an AES security password for turning on AES security is checked at decision 508. If AES security password is not correct at decision 508, then the AES security will not be enabled (i.e., “encryption/decryption OFF”). The process 500 follows the “no” branch back to 504.

If the AES security password is correct at decision 508, the process 500 changes the state to “AES security ON” or “encryption/decryption ON” at 510. As a result, unencrypted data are encrypted before sending to the device and encrypted data are decrypted after receiving from the device 320 as indicated in data path 512. Data encryption and data decryption are performed in the AES security engine 312 using a key. The same key may be used for encrypting all of the data to be stored on the device. Alternatively, a different key may be used for each individual data file, when data file is optionally protected by a data file password. The key would be generated using the data file password, which is then associated with the data file as an overhead or metadata. For example, the overhead may be appended to the corresponding data file, or the overhead may be stored in a designated storage area at 514. Optional data file password is either created or retrieved for writing or reading a data file. Data encryption and decryption becomes a data file dependent in this situation hence higher security achieved. According to another embodiment, AES encryption and decryption is performed with one master encryption/decryption key (i.e., the key associated with the decision 508), even if each data file is protected by a specific data file password. Next at decision 516, a command (e.g., a signal, an interrupt, etc.) for exiting AES security is checked. If “no”, the process 500 remains at “encryption/decryption ON” state at 510. Otherwise, the process 500 follows the “yes” branch to 504 back to “encryption/decryption OFF” state. Because data encryption and decryption and key generation are performed in the AES engine 312 located on the host 310, the device 320 operates in a normal operation 518.

Referring now to FIG. 5B, which is a flowchart illustrating an exemplary process 540 of providing data security for the device 340 (e.g., PESD) with the AES security engine 342 on the device 340 in the second exemplary environment (FIG. 3B). The process 540 applies to the third exemplary environment (FIG. 3C) due to a same data transmission procedure. The following descriptions are for the second environment.

The process 540 starts when the device 340 is electrically and physically connected to the host 330 via the interface bus 315. For example, a USB flash memory device is plugged into a USB receptacle of a computer. The device 340 receives power and signals from the host 330 through the interface bus 315 and is initialized at 542. The host 330 loads a device control program from the device 340 at 543 and establishes a data transfer session. With the device control program running on the host 330 at 545, data transmission is conducted between the host 330 and the device 340 in “no AES security” mode. The device 340 is set to an “AES security OFF” or “encryption/decryption OFF” state at 544. This state will be reset when a request to turn on AES security from the host 330 at 547 is received. Included in the request is an AES security password, which is then sent to the device 340 for verification at decision 546. The AES security password may be retrieved from a special location on the host 330 or created by a user (i.e., enter a password). If the AES security password is incorrect at decision 546, the AES security request is denied and device remains in the “AES security OFF” state. If the AES security password is correct, the process 540 sets the device 340 to an “AES security ON” or “encryption/decryption ON” state at 548. In the “AES security ON” state, an encryption/decryption key is activated. The key may be created in a number of ways, for example, provided by manufacturer of the device; inputted by a user; generated by using the AES password, etc.

When the device 340 is in the “AES security ON” state, the device 340 continuously checks each data access command (read or write request from the host 330 at 549) at decision 550. Once a read/write command is received, the device 340 performs an optional data file password request to the host 330 at 552. The host 330, upon receiving the data file password request, prompts the user to enter a data file password at 551. The data file password may comprise a simple password, a security phrase, reminder hints for password, and the likes. The user entered data file password is then transmitted to the device 340. The AES security engine 342 may use the data file password to generate a data file dependent key to encrypt the associated data file in a data write operation at 554. The data file password is appended to the associated data file as an overhead or metadata. In a data read operation, the AES engine 342 extracts the overhead or metadata to obtain the stored password. If user entered data file password matches the extracted password, the data file is decrypted at 554. Since the data encryption and data decryption are performed by the AES security engine 342 on the device 340, the data sent and received at the host are conducted normally at 555. The “AES security ON” state is terminated when an exit command is detected by the device 340 at decision 556. The command is sent from the host 330 at 557. Once the security termination command is confirmed, the device 340 is set to “AES security OFF” state at 544. Otherwise, the device 340 stays in the “AES security ON” state at 548.

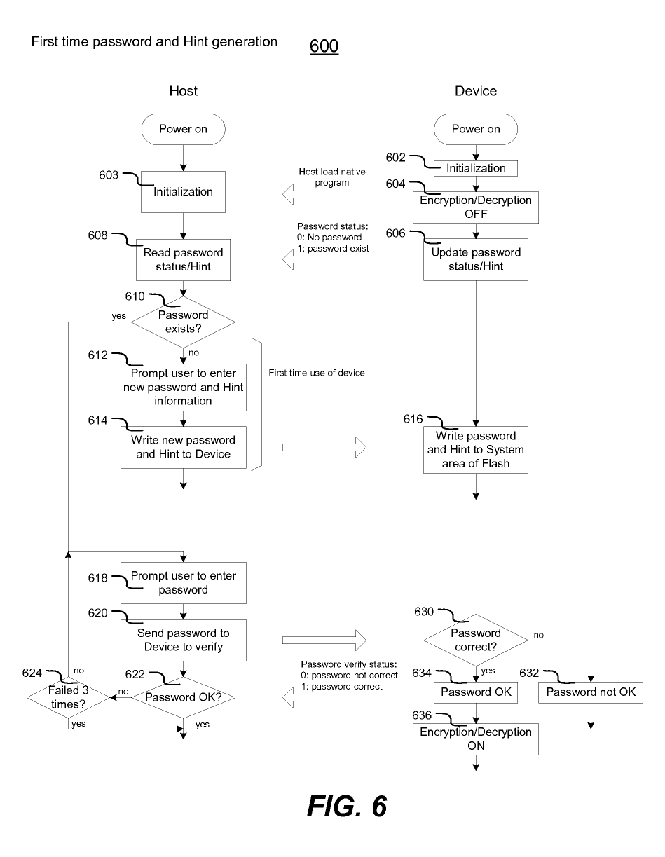

FIG. 6 shows a flowchart for a password creation process 600. The second environment (FIG. 3B) is used for describing the password creation process 600 below. The process 600 starts when the device 340 is electrically connected to the host 330. Signals and power are drawn from the host 330 to the device 340 as the device is initialized at 602. A device control program is loaded and initialized on the host 330 at 603. The default state for the device 340 is set to “encryption/decryption OFF” at 604. Next, at 606, the device sends password status of the device to the host. For example, the password status may comprises one bit of data with zero (0) indicates no password and one (1) represents password exists on the device. The host reads the password status at 608 and checks the status at decision 610. If there is no password on the device, then the decision 610 becomes no. The host prompts user to enter a password and/or password hints at 612. The password hints may comprise a special name, a special event or a phrase for reminding user in case of forgotten password. At 614, the new user entered password is sent to the device. Upon receiving the newly entered password, the device writes or stores the password and/or hints to a secured system area of the flash memory at 616. The stored password on the device may be hashed or scrambled in a particular manner that can only be understood by the device.

If the decision 610 is true, that means there is a password existed on the device. The host prompts user to enter a password at 618 and transmits the user entered password to the device at 620. The device checks the received user entered password at decision 630. If it is determined that the user entered password is not correct, the device stays in the “encryption/decryption OFF” state at 632. Otherwise, the device turns on data security by setting the state to “encryption/decryption ON” at 634 and 636. In order to handle user error in the process of entering the password, the result of the decision 630 is sent back to the host in a password verification status. The password status may comprise a single bit data indicator; for example, one (1) for the correct password and zero (0) for the incorrect password, or vice versa. The password verification status is then checked at decision 622 in the host. If the password verification status indicates a correct password, the host will start data transmission. Otherwise, data is not transmitted by the host 330, the process 600 moves back to 612 prompting user for another password entry. When the number of repeated password entries is larger a predefined maximum (e.g., three (3)), the decision 624 becomes true. And the host 330 will not allow any additional password entry attempt. In certain more strict implementation, the files may be erased for security purpose if the number of password entry attempts is higher than the pre-defined threshold.

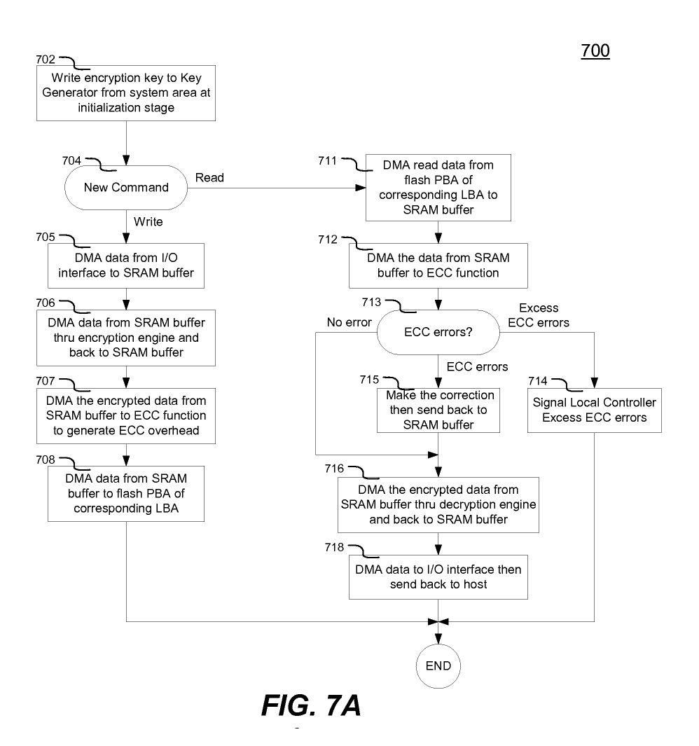

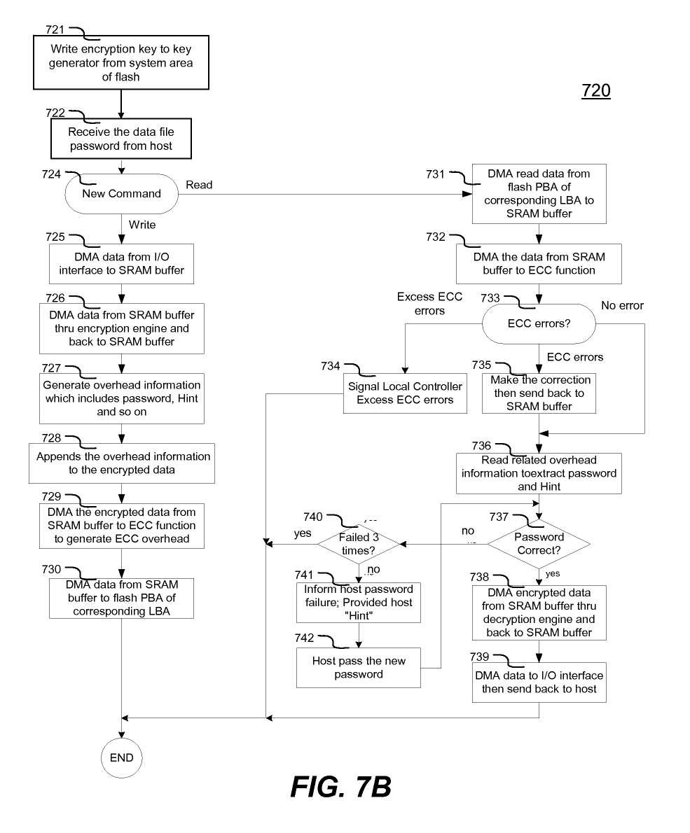

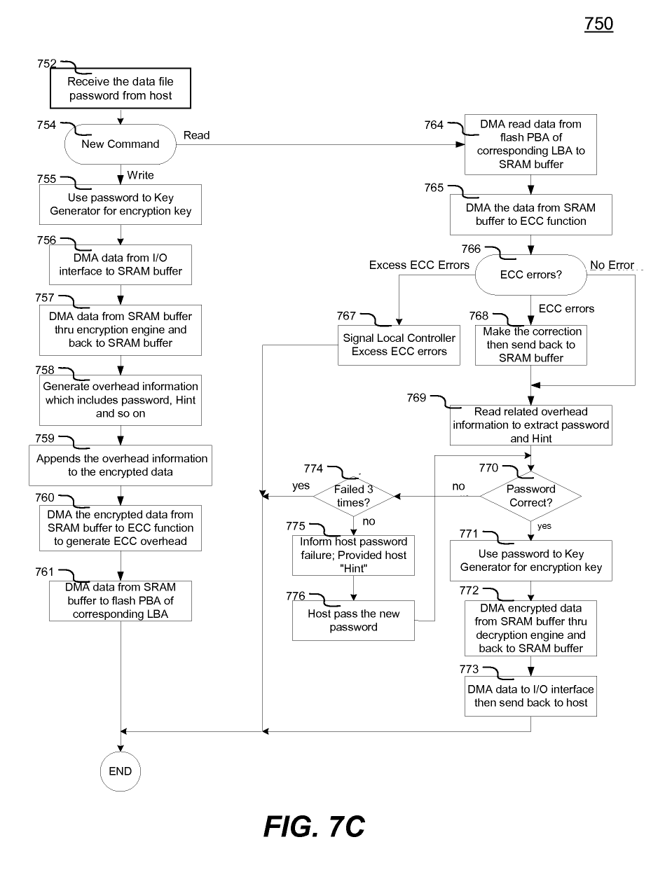

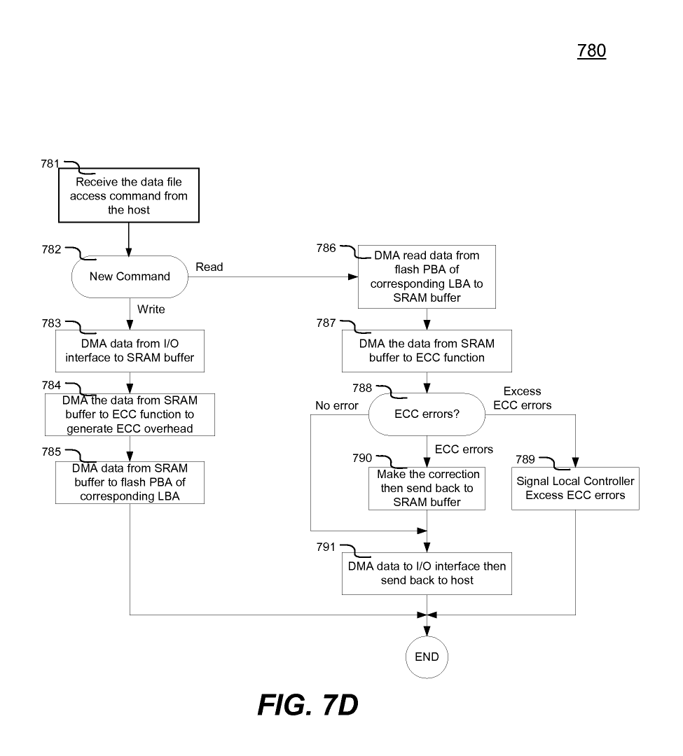

FIG. 7A is a flowchart showing an exemplary process 700 of performing data file reading and writing using data encryption and decryption in an AES engine using one key created by manufacturer of a PESD, according to an embodiment of the present invention. The process 700 is preferably understood in conjunction with previous figures especially FIG. 4A and FIG. 4B.

Process 700 starts with the AES security engine 410 writes the encryption/decryption key to the key generator 434 at 702. The key is created by the manufacturer of the device 400 (PESD) and stored in the system area of the flash memory. When a new data access command arrives, the AES security engine 410 determines whether it is a data “read” or “write” command at decision 704. If the command is a data write command, the AES security engine 410 accesses the data from the I/O interface 402 to the SRAM buffer 408 with direction memory access (DMA) scheme at 705. Next at 706, the data in the SRAM buffer 408 is encrypted in the AES encryption block 442 through the in-buffer 430 in conjunction using the key from the key generator 434. The encrypted data is then written back to the SRAM buffer 408 via the out-buffer 450. Then the encrypted data in the SRAM 408 is accessed by the data error corrector (i.e., other function logic 412) to include ECC overhead information (i.e., parity or error code) to enhance data reliability at 707. Finally at 708, the ECC processed data in the SRAM buffer 408 is written to the flash memory 418 through the flash memory interface 414. Logical block address (LBA) of the “write” data is converted into physical block address (PBA) of the flash memory 418. The data “write” command ends after step 418. A variety of flash memory devices will be described below in FIGS. 9A-9G.

Referring back to decision 704, when the data access command is a data “read” command, the AES security engine 410 retrieves the data (e.g., DMA) from the flash memory device 418 to the SRAM buffer 408 at 711. PBA of the flash memory is converted to LBA in the SRAM buffer. Next at 712, the retrieved data in the SRAM buffer 408 is checked for error by the data error corrector. At decision 713, it is determined whether there are excessive amount of errors in the retrieved data in the SRAM buffer 408. If there are excessive errors, the excessive error condition is reported to the local controller 404 that the data cannot be read and recover at 714 before process 700 ends. If there are errors that can be corrected or recovered, the retrieved data is corrected by the data error corrector and stored back to the SRAM buffer 408 at 715. If there is no error, the process 700 moves directly to 716. At 716, the encrypted data in the SRAM buffer 408 is accessed by the AES decryption block 444 through the in-buffer 430. The decryption is performed using the key from the key generator 434 (written from the system area at step 702). The decrypted data is then written back to the SRAM buffer 408 through the out-buffer 450. Finally, at 718, the unencrypted data is send to the host via the I/O interface 402 to complete the data “read” operation.

FIG. 7B is a flowchart showing an exemplary process 720 of performing data file reading and writing using data encryption and decryption in an AES engine using one encryption/decryption key created by manufacturer of a device 400 (PESD) with additional security provided by a data file password for each data file, according to another embodiment of the present invention. Similar to FIG. 7A, the process 720 is preferably understood in conjunction with previous figures especially FIG. 4A and FIG. 4B.

The process 720 starts with the AES security engine 410 writes the encryption/decryption key to the key generator 434 at 721. Next, at 722, a data file password associated with a data file access command is received at the device 400 (i.e., sent from the host). The device determines the data access command is a data “read” or “write” at decision 724. If a data “write” command is determined, received data are copied from the I/O interface 402 to the SRAM buffer 408 using DMA scheme at 725. Then the unencrypted data in the SRAM buffer 408 is encrypted by the AES encryption block 442 through the in-buffer 430 using the key from the key generator 434. The encrypted data is then written back to the SRAM buffer 408 through the out-buffer 450 at 726. The additional security is created by generating overhead information for each data file based on the data file password at 727. The overhead is then appended or associated with the data file at 728. Next the encrypted data along with the overhead information is processed by the data error corrector at 729. Finally the ECC processed data from the SRAM buffer 408 is written to the flash memory 418 through the flash memory interface 414.

If the data access command is determined as a data “read” command at decision 724. Data stored in the flash memory device 418 for the requested data file are retrieved to the SRAM buffer 408 at 731. Next, the retrieved data is checked for error at 732. At decision 733, if it is determined that there are excessive errors, the data error condition is reported to the local controller 404 at 734 and process 720 ends. If the error is correctable by the data error corrector. The ECC data correction is performed at 735. If there is no error, the process 720 moves directly to 736. At 736, the overhead information for the retrieved data file is read as reference password for authenticating the data “read” request. Then at decision 737, the data file password received from the host is compared with the reference password obtained from the overhead information. If the received data file password matches the reference, the encrypted data in the SRAM buffer 408 is decrypted in the AES decryption block 444 of the AES security engine 410 at 738 before sending the unencrypted data to the host 739.

If the decision 737 determines the data file password is incorrect comparing to the reference password, the process 720 allows the user to re-enter the data file password from the host in predefined number (e.g., three times) of password entry attempts. If user has not exceeded the maximum allowed number of password entry attempts, the result of decision 740 is “no”. The user operates the host is given another opportunity to enter the data file password or password hints at 741. The password is then received by the device at 742 for checking at decision 737. If the number of password entry attempts exceeds the allowable, decision 740 becomes “yes”, data file “read” access is denied.

FIG. 7C is a flowchart showing an exemplary process 750 of performing data file reading and writing using data encryption and decryption in an AES engine using encryption/decryption key created for each data file using the data file password, according to yet another embodiment of the present invention. Again, the process 750 is preferably understood in conjunction with previous figures especially FIG. 4A and FIG. 4B.

The process 750 starts by receiving a data file password associated with a data file access command at the device 400 (e.g., a PESD) at 752. The data file access command is then determined at decision 754. If the data file access command is a data “write” command, the data file password is sent to the key generator 434 to generate an encryption key at 755. This means that the key becomes data file dependent instead of one key for the entire device used in the processes 700 and 720. Steps 756 to 761 of the process 750 are the same as steps 725 to 730 of the process 720. The data file “write” command ends after step 761.

Similarly if the data file access command is a data “read” command, steps 764 to 770 of the process 750 are the same as the steps 731 to 736 of the process 720. If it is determined that the received data file password at 752 matches the password extracted from the overhead information of the request data file, the result of the decision 770 is “yes”, and the matched data file password is sent to the key generator 434 to generate a decryption key at 771. Then the encryption data in the requested data file are decrypted in the AES decryption block 444 of the AES security engine 410 at 772. The decrypted data is written to the SRAM buffer 408 before sending to the host through the I/O interface 402 at 703.

If the received password is determined to be incorrect at the decision 770, the following steps 774 to 776 of the process 750 are the same as the steps 740 to 742.

Referring now to FIG. 7D, which is a flowchart showing an exemplary process 780 of performing data file reading and writing without AES security or in the state of “encryption/decryption OFF” in accordance with one embodiment of the present invention.

The process 780 starts by receiving a data file access command from the host at 781. Next, at decision 782, the data file access command is determined whether it is a data “read” or “write” command. If the command is data “write”, data of the data file is written to the SRAM buffer 408 through the I/O interface 402 using DMA scheme at 783. Then the data in the SRAM buffer 408 is processed by the data error corrector at 784, in which ECC overhead information is created for data reliability. Finally, the ECC processed data in the SRAM buffer 408 is written to the flash memory 418 through the flash memory controller 414 at 785.

If the data file access command is a data “read” command, the device retrieves data of the requested data file from the flash memory 418 to the SRAM buffer 408 at 786. Next, at 787, the retrieved data in the SRAM buffer 408 is checked for error in the data error corrector. At decision 788, if it is determined that there are excessive ECC errors, the data error condition is reported to the local controller 404 at 789 and the process 780 ends. If the data error can be corrected, the ECC data correction procedure is performed at 790 to correct the error. If there is no data error determined at decision 788, the process 780 goes directly to 791, in which the data in the SRAM buffer 408 is sent to the host through the I/O interface 402. It is noted that the AES security engine 410 is not used in any step of the process 780.

To support various AES security measures described above, flash memory devices of greater capacity are used in some embodiments. Advances in flash technology have created many types of flash memory device. For example, Multi-Bit Cell (MBC) or Multi-Level Cell (MLC) flash memory devices have a higher capacity than Single Bit Cell (SBC) or Single-level cell (SLC) flash memory devices for the same form factor. In general, SLC type of flash memory cells is more reliable with higher data transmission rate, while MLC type flash memory cells is more economical. SLC type flash memory cells may include Small Block SLC (SSLC) and Large Block SLC (LSLC). Likewise, MLC type of flash memory cells may include Small Block MLC (SMLC) and Large Block MLC (LMLC). Flash memory with SMLC is typically arranged into 512+16 bytes per page, while flash memory with LMLC is 2048+64 bytes per page. The “+16” bytes and “+64” bytes are spare area for each page. A page is the unit used for data access (read or write). Therefore, the data access speed depends upon the size of the page. A larger page size (e.g., 2048 bytes) flash memory has a better data write performance against a smaller page size flash memory (e.g., 512 bytes). To support larger page size, the flash memory controller (e.g., controller 404 of FIG. 4A) needs to control (e.g., detect and access) the page size accordingly.

A typical flash memory device contains an identification (ID) code that shows the flash memory type, the manufacturer and characteristics of the flash memory such as page size, block size, capacity, etc. Read ID code information is performed when the device (e.g., PESD) is electrically and physically connected to a host during the initialization.

In one embodiment, the flash memory controller is configured with a 512-byte page register (e.g., SRAM buffer 408 of FIG. 4A). Data to be read from and written to the flash memory need to be copied to the register first for various processing (e.g., encryption/decryption, ECC data error recovery, etc.). The data access is performed in a sequential block by block order. Each data access is limited to a 512-byte page.

In another embodiment, the flash memory controller is configured with a larger register (e.g., 2048-byte, 4096-byte, etc.). The larger register allows multiple of 512-byte data transfer performed in parallel, therefore improving the data transfer performance. One example of the larger register PESD is based on MLC flash memory, which may comprise 2048-byte per page. However, there is a limitation as to writing data into each block. A block becomes restricted when the block is partially written. This problem is referred to as “Partial Write Prohibited” or “NOP=1 (Number of Program equal to 1)”. The term “Program” means writing data to the flash memory. With many of the convention flash memory controller configured to perform a 512-byte data transfer, the larger block sized flash memory encountered the “Partial Write Prohibited” problems. Since the present invention may be implemented on a PESD using MLC based flash memory, the “Partial Write Prohibited” problem needs to be avoided to ensure higher data transfer speed.

The solution to this problem is described below using a 2048-byte block sized flash memory (e.g., MLC flash memory) as an example. The solution uses a page mapping scheme in a flash memory controller to avoid multi-time programming to one physical block of the flash memory.

TABLE 1A

| physical block | 0 | 1 | 2 | 3 | 4 | 5 | 6 | 7 |
|---|---|---|---|---|---|---|---|---|
| logical block | 1 | 5 | 63 | 63 | 63 | 63 | 63 | 63 |

TABLE 1B

| physical block | 0 | 1 | 2 | 3 | 4 | 5 | 6 | 7 |
|---|---|---|---|---|---|---|---|---|
| logical block | 1 | 5 | 8 | 63 | 63 | 63 | 63 | 63 |

TABLE 1C

| physical block | 0 | 1 | 2 | 3 | 4 | 5 | 6 | 7 |
|---|---|---|---|---|---|---|---|---|
| logical block | 1 | 5 | 8 | 8 | 63 | 63 | 63 | 63 |

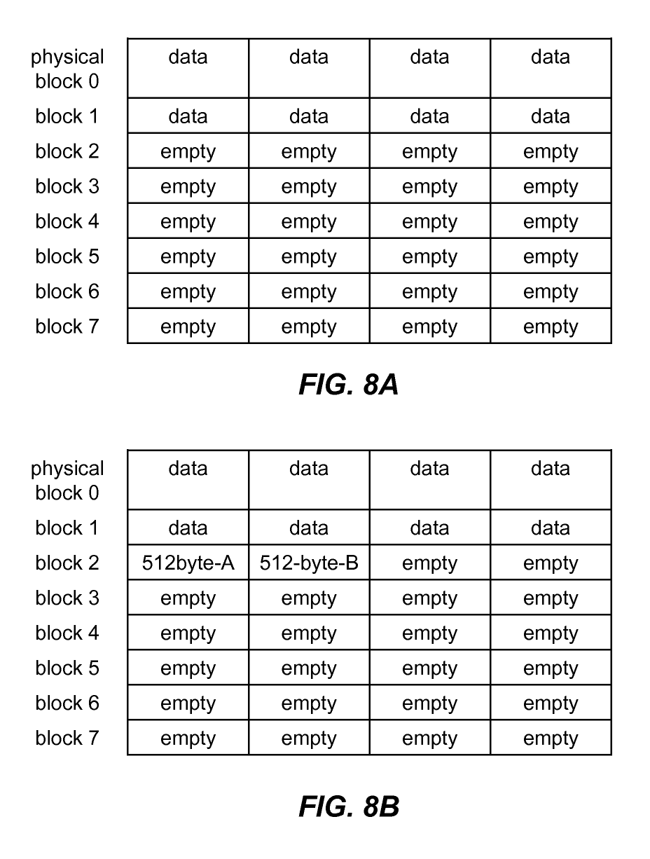

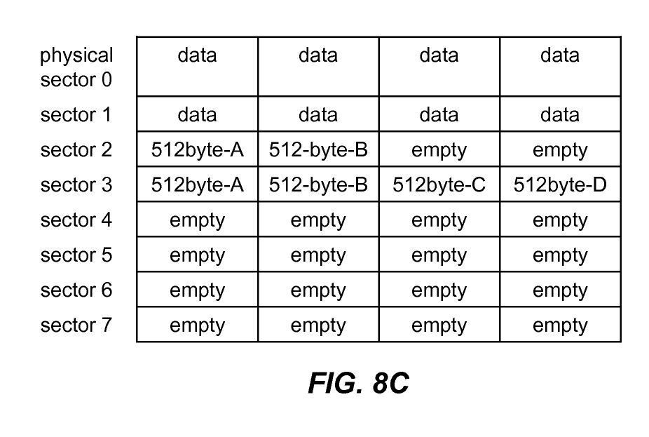

FIG. 8A-8C and Table 1A-1C collectively show how the flash memory controller solves this problem in MLC based PESD. FIG. 8A shows eight physical blocks with 2048-byte per block. There are valid data stored in physical blocks 0 and 1 and the rest are empty. Table 1A is a correlation table between physical block number of the flash memory and logical block number of the data to be written. The first row of Table 1 lists physical blocks from block zero (block 0) to block seven (block 7). The second row lists the corresponding logical block number to the physical block numbers. For example, physical block 0 corresponds to logical block 1 and physical block 2 corresponds to logical block 5. The rest of the logical block numbers is shown as sixty-three (63), which is a 6-digit binary number of one's (i.e., b‘111111’). That is an indicator for empty flash memory as shown in FIG. 8A.

After a first 1024-byte data write command from the host is received and executed on the PESD, updated status of the flash memory is shown in FIG. 8B and Table 1B. FIG. 8B shows the 1024-byte data is written in two pages of 512-byte in physical block 2 of the flash memory. Table 1B shows that the logical block 8 corresponding to physical block 2. As a result, the physical block 2 has been partially written.

Then a second 1024-byte data write command has arrived from the host. Although there is enough space to hold newly arrived second 1024-byte data, the limitation of “Partial Write Prohibited” prevents the device to store or write into physical block 2. It would need to find the next available space which is physical block 3. However, that would cause physical block 3 becoming partially written. As a result, the large page flash memory such as MLC based flash may be wasted due to this problem. One solution to this problem is to have the controller to do page mapping before writing to the flash memory. For example, the first 1024-byte data in the partially written physical block 2 and the newly arrived second 1024-byte data are mapped in the register (i.e., a 2048-byte register or SRAM buffer) before writing to the next available physical block 3 as shown in FIG. 8C. Table 1C reflects the new data in the physical block 3, which corresponds to logical block 8. This scheme ensures partially used spaces are optimized to reduce waste.

To access data, the controller searches the logical block number in Table 1C backwards starting from physical block 7 to physical block 0. The first matched logical block is the newest updated data. For example, physical block 3 corresponds to logical block 8 in Table 1C. When the controller searches for the logical block 8, the first encountered location is physical block 3. Although the logical block 8 also corresponds to physical block 2, the controller would not select this because physical block 3 is always searched first. In other words, only the last of repeated logical block numbers is the newest data. All of the earlier ones can be regarded as “out-of-date” data block.

According to one embodiment of the present invention, the encrypted data created by the AES security engine 410 of FIG. 4A needs to be written or stored in the manner described herein for MLC based flash memory.

The flash memory device shown and described above in FIG. 4A may comprise many different types. FIGS. 9A-9G are block diagrams illustrating various data access schemes between a flash memory controller and flash memory including Single-Level-Cell and Multi-Level-Cell. Due to data reading and writing in a flash memory device requiring access and verification. The data access speed is a major concern to ensure a good device performance.

In one embodiment, a PESD comprises a flash memory controller 902 and an 8-bit based flash memory integrated circuit (IC) chip 904 shown in FIG. 9A. The controller 902 controls the flash memory IC chip 904 via an 8-bit data bus, which is referred to as single-channel data bus. In another embodiment shown in FIG. 9B, A PESD comprises a flash memory controller 912 and a 16-bit data bus based flash memory IC chip 914. The 16-bit data bus is referred to as dual-channel data bus. The dual-channel data bus in general provides two times of speedup in comparing with the single-channel data bus does.

In yet another embodiment shown in FIG. 9C, a PESD comprises a flash memory controller 922 and two 8-bit based flash memory IC chip 924a and 924b. Each of the two chips 924a and 924b is controlled by the controller 922 via an 8-bit data base.

FIG. 9D shows yet another alternative embodiment of a PESD comprising a flash memory controller 932 and an 8-bit based dual-die flash memory IC chip 934. The single channel interleave operation is achieved with two flash memory dies. In yet anther embodiment shown in FIG. 9E, a PESD includes a flash memory controller 942 and an 8-bit based flash memory chip 944 with four dies mounted therein. Alternatively, according to yet anther embodiment, FIG. 9F shows another PESD, which comprises a flash memory controller 952 and four 8-bit based flash memory chip 954a-954d.

FIG. 9G shows a much more complex PESD, which comprises a flash memory controller 962 and a plurality of flash memory chips 964a-964p as a flash memory module. The controller 962 includes sixteen (16) chip-enablers (CS#), four (4) ready/busy (RB#) signals and four (4) channels to control data and signals. The flash memory module may include sixty-four (64) single-channel flash memory dies or chips, thirty-two (32) dual-channel flash memory dies or sixteen (16) quad-channel flash memory dies.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas the exemplary security measure is shown and described using AES security, other types of equivalent security measures may be used. Additionally, whereas the interface bus is described and shown as USB, other data buses may be used such as Peripheral Component Interconnect Express (PCI Express or PCI-E), Serial ATA, Firewire (i.e., IEEE 1394), small computer system interface (SCSI), etc. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A portable electronic storage device (PESD) comprising:
a security means for providing data encryption and data decryption when required, the security means includes a key generator for generating and/or holding a key used for the data encryption and the data decryption;
a flash memory configured to provide data storage;
a controller or micro-controller configured to control the flash memory and the security engine; and
an internal data bus configured to provide data and control signal transmission among the controller, the security means and the flash memory within the PESD.

2. The device of claim 1 further comprises a data error corrector configured to provide data reliability using an error-correcting code (ECC) technique.

3. The device of claim 2 further comprises a page register configured to hold data in a static random access memory for fast direct memory access.

4. The device of claim 3 further comprises an input/output (I/O) interface configured to provide data transfer between a host and the PESD.

5. The device of claim 1, wherein the security means comprises integrated circuits electrically mounted on the device.

6. The device of claim 1, wherein the key comprises at least 128 bit.

7. The device of claim 6, wherein the key is created by manufacturer of the PESD and stored in a system area of the flash memory.

8. The device of claim 1, wherein the data encryption and data decryption is required when a data security mode is requested by a user with a data security password.

9. The device of claim 1, wherein the data encryption and data decryption transforms data with influence based on the key.

10. The device of claim 1, wherein the key generator generates a data file dependent key for each of those data files requiring a data file password, which provides additional data security to data stored on the PESD.

11. The device of claim 10, wherein the data file password is rehashed and appended to corresponding one of the data files as overhead information.

12. The device of claim 1, wherein the data storage in the flash memory contains a public area for unencrypted data and a secured area for encrypted data.

13. The device of claim 1, wherein the flash memory is arranged in blocks of multiple pages, the pages are written and blocks are erased, wherein the pages are only erasable by erasing all pages in the block.

14. The device of claim 13, wherein the flash memory comprises multi-level cell based flash memory.

15. The device of claim 13, wherein the flash memory includes one or more flash memory integrated circuit dies.

16. A process of providing data security to a portable electronic storage device (PESD) comprising:
initializing a PESD when electrically connected to a host; and
conducting data operation with secured means when a data security password has been verified, the secured means includes data encryption and data decryption and optionally data file password protection; wherein conducting data operation includes writing or storing data to a flash memory and reading the stored data from the flash memory.

17. The process of claim 16, wherein the data encryption and data decryption is performed in a security engine in accordance with Advance Encryption Standard.

18. The process of claim 16 further comprises performing data error correction using error-correcting code technique for enhancing data reliability.

19. The process of claim 16 further comprises conducting authenticity check by comparing user entered password against a reference password, and conducting password hints procedure to help user to recover forgotten password.

20. The process of claim 19 further comprises limiting the user password entry attempts to a predefined maximum.
